(19) United States
(12) Patent Application Publication
(10) Pub. No.: US 2003/0105804 A1
(43) Pub. Date: Jun. 5, 2003

(54) Communication system with personalized call handling

(75) Inventors: Robert Turner, Kanata (CA); Behrouz Poustchi, Kanata (CA)

Correspondence Address: OGILVY RENAULT, 1981 MCGILL COLLEGE AVENUE, SUITE 1600, MONTREAL, QC, H3A2Y3, CA

(73) Assignee: OBJECTWORLD, Hull (CA)

(21) Appl. No.: 09/991,794

(22) Filed: Nov. 26, 2001

(51) Int. Cl. G06F 15/16

(52) U.S. Cl. 709/203; 709/249; 379/93.24

(57) ABSTRACT

A communication system, a CTI (computer telephone interface) server that executes a server program, and client computers that execute client programs. The server program can be configured from the client programs to control call handling behaviors for calls from a telephone network or internal telephone extensions based on the configuration of the server program by the client programs.

### CROSS-REFERENCE TO RELATED APPLICATIONS

This is the first application filed for the present invention.

### TECHNICAL FIELD

The invention relates in general to communication systems and in particular to communication systems with personalized call handling.

### BACKGROUND OF THE INVENTION

A problem with known office voicemail and messaging systems arises because different users served by these systems need personalized call processing. In an office environment, for example, each individual's call handling needs are generally unique. In addition, since individual users work with different contacts (either internal or external to their organization), it is desirable to provide message handling that is customizable based on personal contacts. Users of the known systems cannot personalize call-flow behavior for calls arriving at their desktop phone in any extensible manner. Typical systems available today permit users to change greetings, in some cases using rules based on time-of-day and the source of the call, to configure limited notification rules (pager, etc.) based on restrictive criteria, and possibly create simple single-layer menus or forwarding options for callers. Typically, those systems also only function as configured while the user's computer is attached to their network. Other systems allow system administrators to write custom scripts, often in custom programming languages, to instruct private branch exchanges (PBXs) to direct calls to custom computer telephone integration (CTI) systems that execute those scripts. This requires that the system administrator have extensive knowledge and experience. The system administrator's time is also consumed writing frequent iterations and redeveloping scripts for the user as a result of miscommunications, changes of desire, etc. Furthermore, many of the custom, non-integrated CTI systems do not interact effectively with voice mail and personal contact management systems.

### SUMMARY OF THE INVENTION

It is an object of the invention to provide a communication system that permits users within an office to personalize call processing and notification based on personal contacts, and permits personalization of call flow in an extensible manner, without requiring extensive knowledge of the system by the user.

According to one aspect of the invention there is provided a communications system for use in conjunction with a telephone system connectable to a telephone network, the telephone system supporting a plurality of extension telephones connected thereto and used by a plurality of users with personal computers connected to a computer network. The system includes a CTI (computer telephony integration) server connected to the computer network, the CTI server executing a server program that executes computer instructions for handling calls to at least selected ones of the plurality of extension telephones; and a client program installed on the personal computers, each client program having means for configuring the server program to execute the computer instructions for handling calls to an extension telephone of the user.

According to another aspect of the invention there is provided a method of permitting an individual user of an extension telephone to configure the handling of calls to the extension telephone, the extension telephone being connected to a telephone system connected to a telephone network. The method includes steps of: communicatively connecting a client program operated by the individual user to a server program that executes on a CTI server configured to receive notice of the calls to the extension telephone and to control handling of the calls; creating a call flow map that defines how the calls are to be handled using the client program operated by the individual user; and operating the client program to store the call flow map on the CTI server.

According to another aspect of the invention there is provided a method for processing calls to a plurality of extension telephones in a communications system that includes a network; a CTI server connected to the network; a telephone system connected to the CTI server and to a telephone network; and a plurality of extension telephones connected to the telephone system. The method includes steps of: receiving the call at a CTI server, which executes a predetermined service defined by a user of a destination extension telephone for the call using a client program; and handling the call at the CTI server in accordance with the predetermined service.

According to yet another aspect of the invention there is provided a computer readable medium storing program instructions executable by a client computer in a server/client computing model, including: program instructions for communicatively connecting the client computer to a server program executing on a CTI server; program instructions for permitting a user of an extension telephone served by a telephone system to which the CTI server is connected to create at least one call flow map for controlling calls to the extension telephone; and program instructions for saving call flow maps created by the user on the CTI server.

### BRIEF DESCRIPTION OF THE DRAWINGS

Further features and advantages of the present invention will become apparent from the following detailed description, taken in combination with the appended drawings, in which:

FIG. 1 is a schematic diagram of an environment in which the system in accordance with the invention is typically deployed;

FIG. 2a is a block diagram of client program components of the system deployed on the client computer shown in FIG. 1;

FIG. 2b is a schematic diagram of a window of a main user interface of the client program shown in FIG. 2a;

FIG. 3 is an example of a call flow map created using the client program components in accordance with the invention;

FIG. 4 is a schematic diagram of a window of a service editor shown in FIG. 2a;

FIGS. 5a, 5b, 5c and 5d are a sequence of diagrams showing connection of service editor elements to create a call flow map;

FIG. 6 is a diagram showing resizing of an element using T-bar control;

FIG. 7a, is a block diagram of a server program shown in FIG. 1;

FIG. 7b, is a block diagram of components of the server program shown in FIG. 7a;

FIG. 8a, is a block diagram of components of the server program shown in FIG. 7a;

FIG. 8b, is a schematic diagram of user profile data shown in FIG. 8a;

FIG. 9, is a block diagram of components of the server program shown in FIG. 7a;

FIG. 10 is the schematic diagram shown in FIG. 1, illustrating steps of configuring a call flow map; and

FIG. 11 is the schematic diagram shown in FIG. 1, showing steps of handling an incoming call.

It will be noted that throughout the appended drawings, like features are identified by like reference numerals.

### DETAILED DESCRIPTION OF THE PREFERRED EMBODIMENT

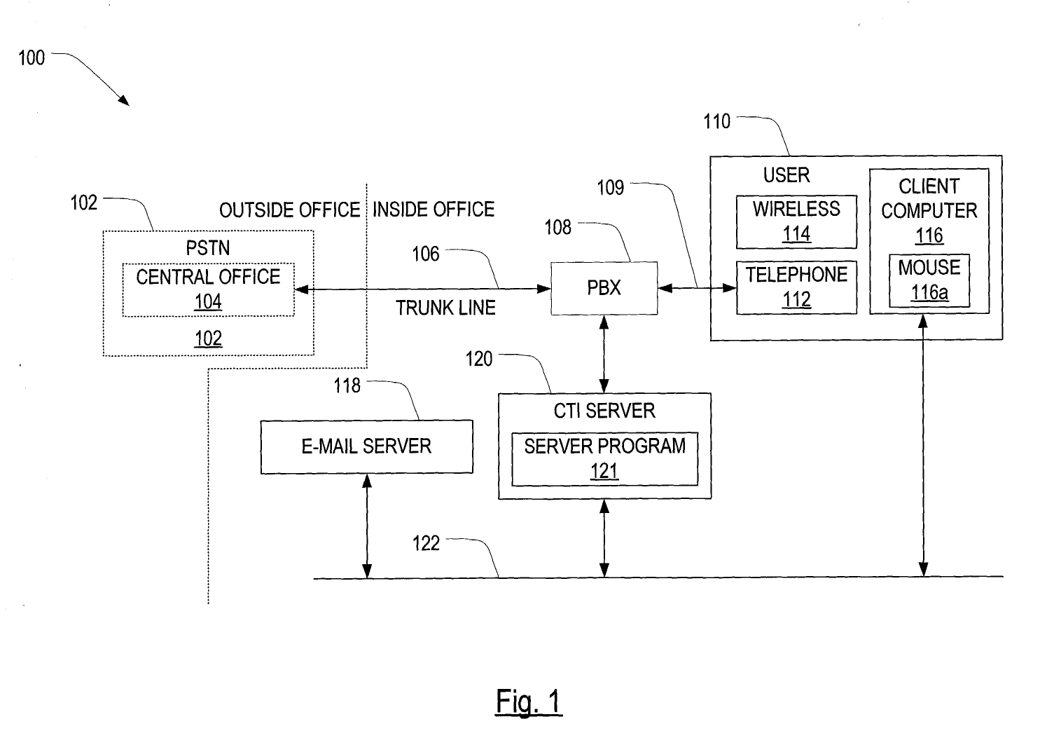

FIG. 1 is a schematic diagram of an environment 100 in which the system in accordance with a preferred embodiment of the invention is typically deployed. The environment 100 includes a PSTN (public switched telephone network) 102 (shown in dotted outline) having a central office 104 connected to a telephone system 108 which may be a PBX, a key-system or IP (Internet protocol) telephony solution, via one or more trunk lines 106 (only one of which is shown for convenience). A plurality of users 110 (only one shown for convenience) each have a telephone 112 connected to the telephone system 108 via an extension 109; wireless devices 114 such as pagers or cellular telephones; and client computers 116 are connected to a network 122. The client computer 116 may be, for example, a personal computer system running an operating system such as a version of Windows® (for example 95®, 98®, NT®, ME®, 2000®or XP®) or Linux® and has a pointing device such as a mouse 116a. The network may be, for example, a TCP/IP (transport control protocol/Internet protocol) based LAN (local area network) or VPN (virtual private network) that may be connected to an inter-network such as the Internet. The environment 100 also includes a CTI (computer telephone interface) server 120, having a server program 121. The CTI server 120 is connected to the telephone system 108 and the network 122. An email server 118 is also connected to the network 122. The CTI server 120 may be, for example, a Nortel Norstar KSU® having a Dialogic® D/82JCT-U card. The email server 118 may be, for example, a Microsoft Exchange® server.

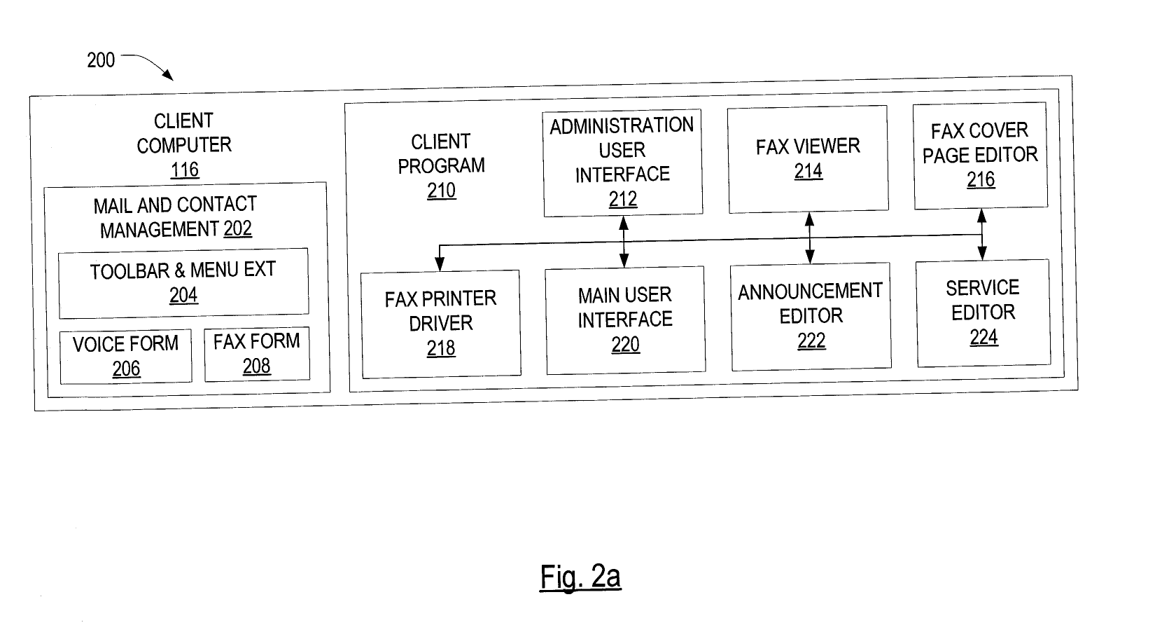

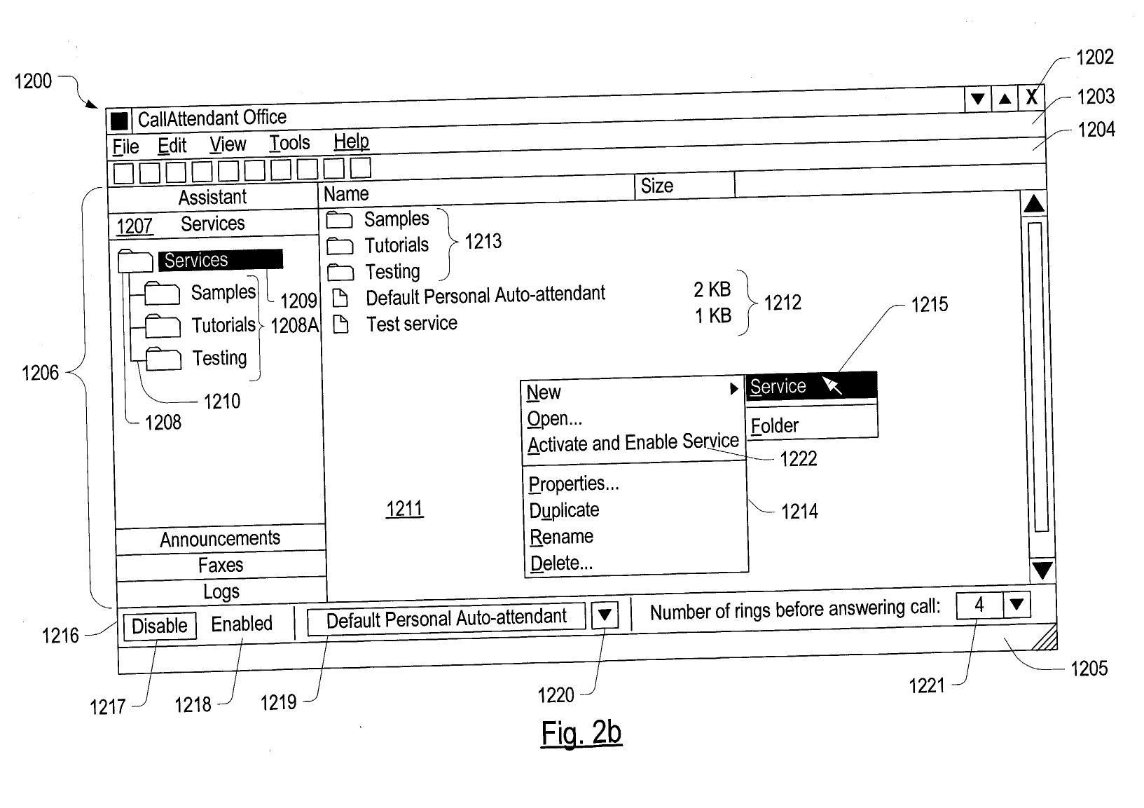

FIG. 2a is a block diagram of client software components 200 utilized by the system in accordance with the invention. The client software components 200 include a mail and contact management system 202 and a client program 210. The mail and contact management system 202, which may be Microsoft Outlook®, or a third party PIM (personal information manager) for example, has toolbar and menu extensions 204, a voice form 206 and a fax form 208. The client program 210 has an administration user interface 212, a fax viewer 214, a fax cover page editor 216, a fax printer driver 218, a main user interface 220, an announcement editor 222 and a service editor 224.

FIG. 2b shows a window 230 of the main user interface 220 shown in FIG. 2a that includes a title bar 232, a menu bar 234, a command bar 236, and a status bar 238. The window 230 also has navigation bars 240 including an active navigation bar 242 (Services in this example). The services navigation bar 242 has a root folder object 244, a selected folder object 246, other folders and file-like objects 244a that are connected by tree-lines 248. The window 230 also has a contents pane 250 that displays service objects 252 and folder objects 254. The window 230 also has a context sensitive menu 256 (preferably activated by right-click of the mouse 116a). In this example, a ‘New|Service’ menu item 258 is selected. The window 230 includes a line status bar 260 that includes a disable/enable call answer button 262; a display 264 of the state of call-answer for the user's extension telephone 112; a display 266 of the active service; an active service pop-up menu 268; and a display of the number of rings after which the telephone will be answered 270. The context sensitive menu 256 includes an ‘Activate and Enable Service’ command 272.

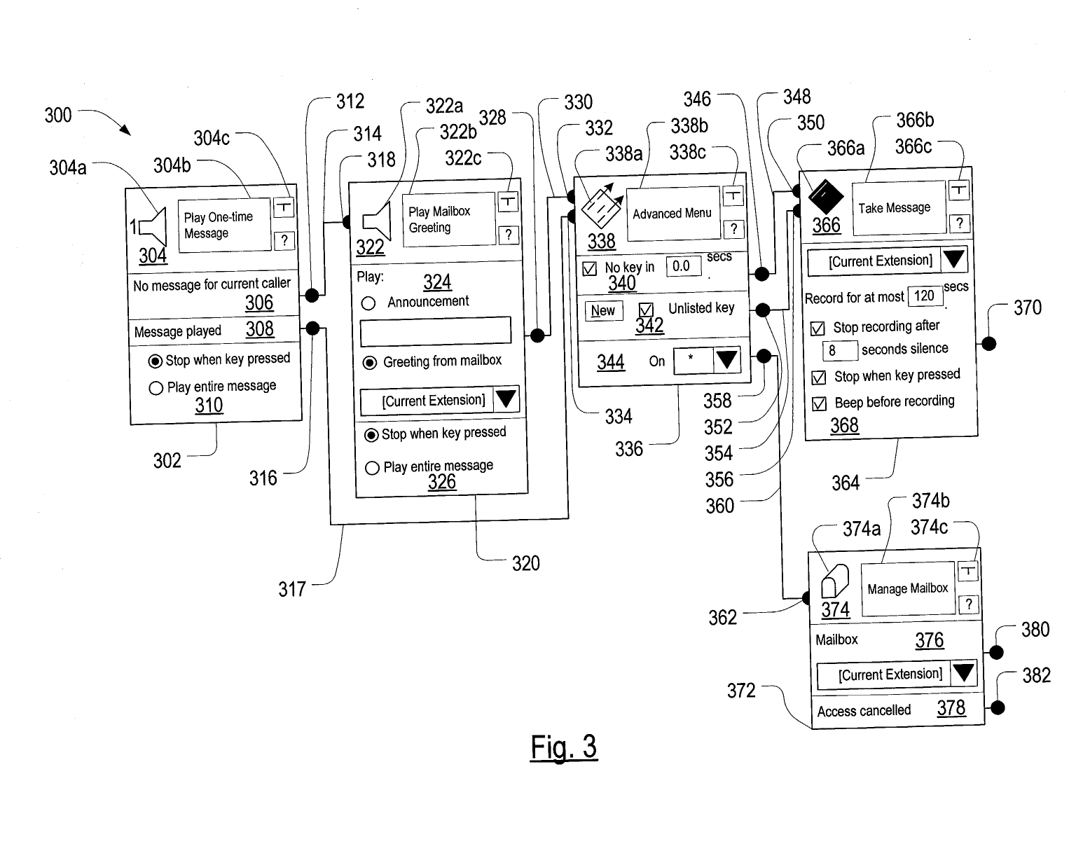

FIG. 3 shows an example of a call flow map 300 created using the service editor 224 shown in FIG. 2a. The call flow map defines a user service by connecting together elements in an intuitive way. The call flow map 300 includes a first element 302, a second element 320, a third element 336, a fourth element 364 and a fifth element 372. The first element 302 includes a header 304 having an icon 304a, a title 304b and a T-bar 304c; a first section 306 having an output connector pin 312; a second section having an output connector pin 316; and a third section 310. The second element 320 includes a header 322 that has an input connector pin 318, an icon 322a, a title 322b, and a T-bar 322c; a first section 324 having an output connector pin 328; and a second section 326. The third element 336 includes a header 338 having a first input connector pin 332, a second connector pin 334, an icon 338a, a title 338b and a T-bar 338c; a first section 340 having an output connector pin 346; a second section 342 having an output connector pin 352; and a third section 344 having an output connector pin 358. The fourth element 364 includes a header 366 that has an icon 366a, a title 366b, a T-bar 366c, a first input connector pin 350 =and a second input connector pin 356; and a section 368 having an output connector pin 370. The fifth element 372 includes a header 374 having an input connector pin 362, an icon 374a, a title 374b, and a T-bar 374c; a first section 376 having an output connector pin 380; and a second section 378 having an output connector pin 382. The output connector pin 312 is connected to the input connector pin 318 by connector 314. The output connector pin 316 is connected to the input connector pin 334 by connector 317. The output connector pin 328 is connected to the input connector pin 332 by connector 330. The output connector pin 346 is connected to the input connector pin 350 by connector 348. The output connector pin 352 is connected to the input connector pin 356 by connector 354. The output connector pin 358 is connected to the input connector pin 362 by connector 360.

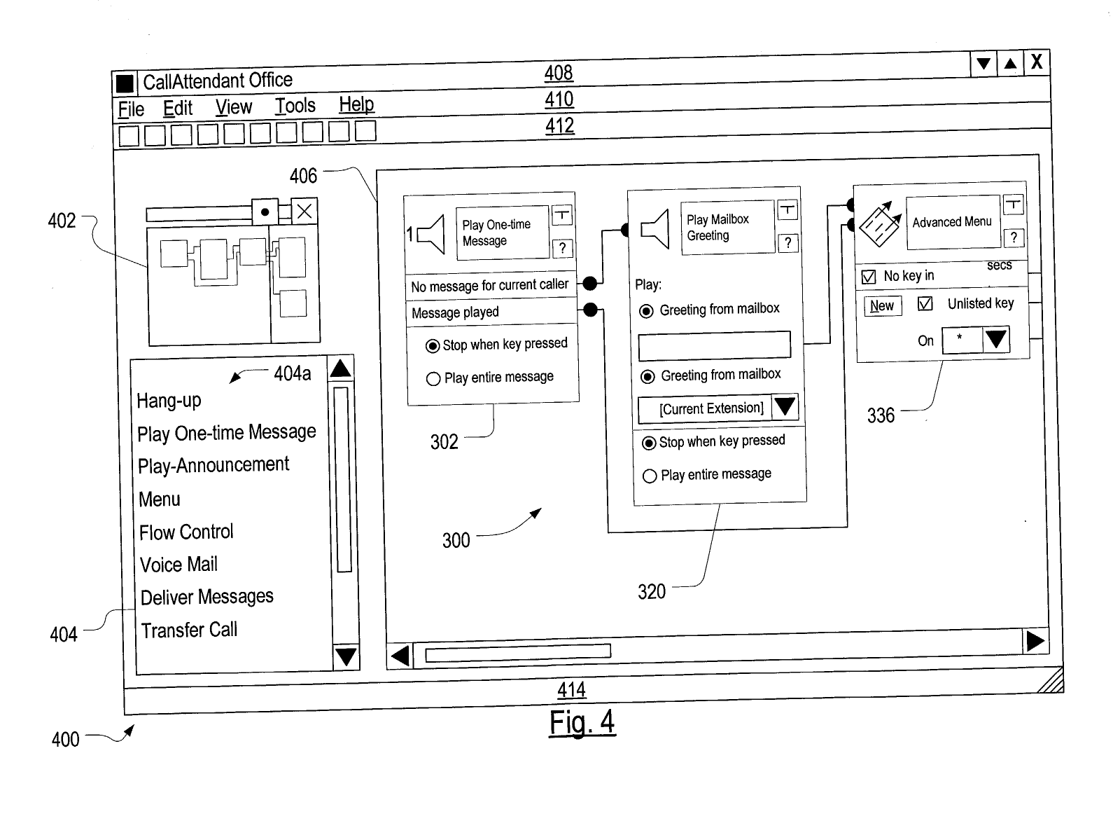

FIG. 4 shows a window 400 of the service editor 224 shown in FIG. 2a. The window 400 includes an overview pane 402, a palette tool 404 having a list of elements 404a that can be used to create a call flow map, and an editor pane 406 in which call flow maps are created. As an example, a portion of the call flow map 300 of FIG. 3 is shown in the editor pane 406. The window 400 also includes a tile bar 408, a menu bar 410, a command bar 412, and a status bar 414, the uses of which are well known in the art.

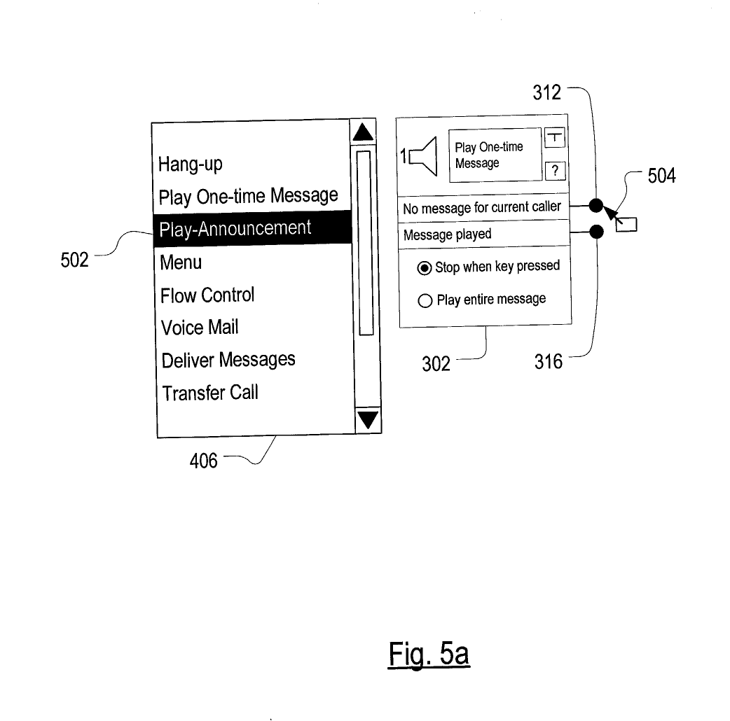

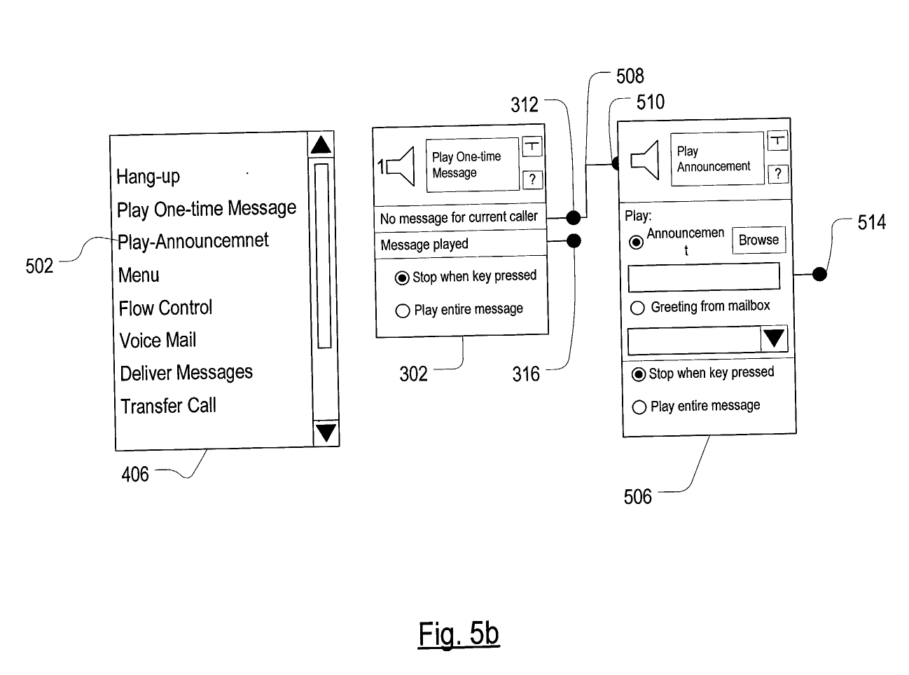

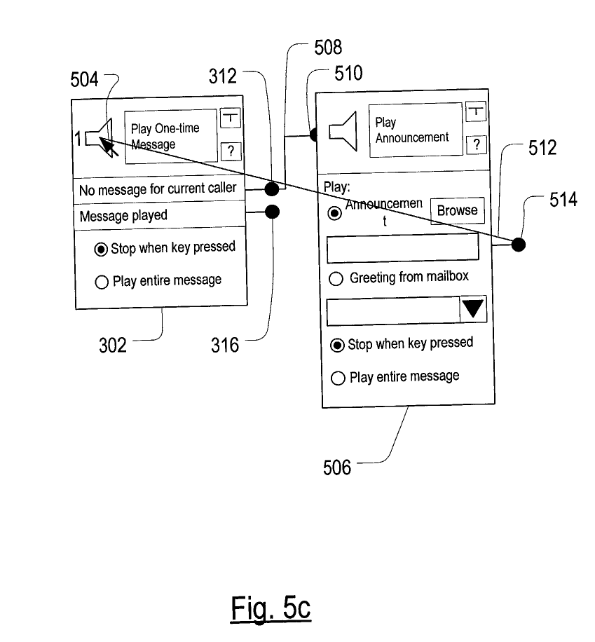

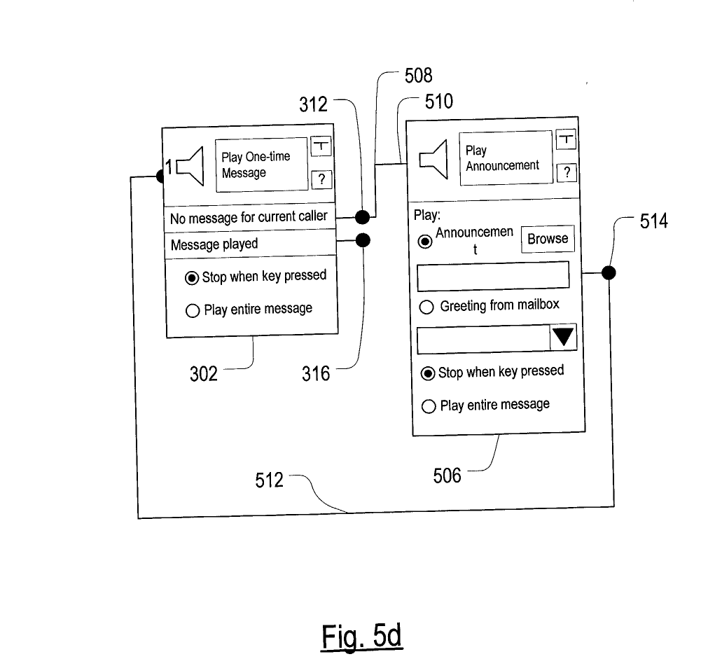

FIGS. 5a and 5b show a step in the creation of a call flow map. An element 506 is dragged and dropped using a cursor 504, by selecting an element name 502 from the palette tool 404 and displaying the output connector pin 312. The element 506 is automatically created and displayed, and the connector 508 is automatically created between the output connector 312 and the input connector 510.

FIGS. 5c and 5d show the creation of a connection 512, which is created by selecting the output pin 514 using the mouse 116a (FIG. 1) and dragging the cursor from the output pin 514 of the element 506 to an element 302. As shown in FIG. 5d, the connection 512 is automatically routed around elements 502 and 506 as part of the automatic creation process.

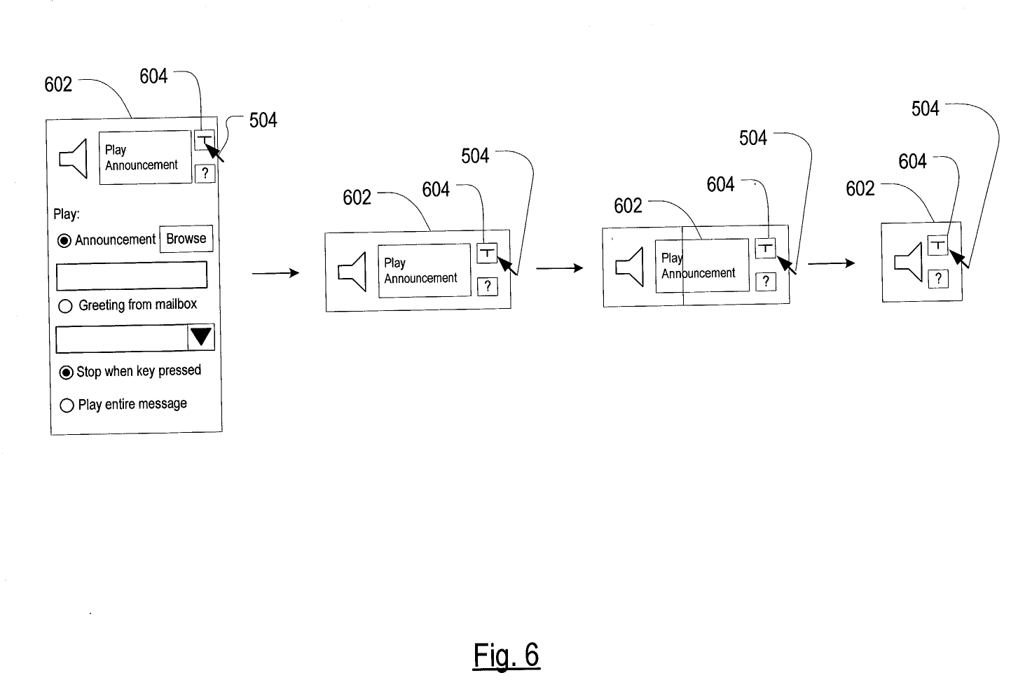

FIG. 6 illustrates how an element can be resized by dragging a T-bar 604a using the cursor 504. T-bar 604a changes to T-bar 604b and T-bar 604c as it is dragged. A ghost image 606 of a target size of the element 602 is also displayed while the T-bar 604a-c is being dragged.

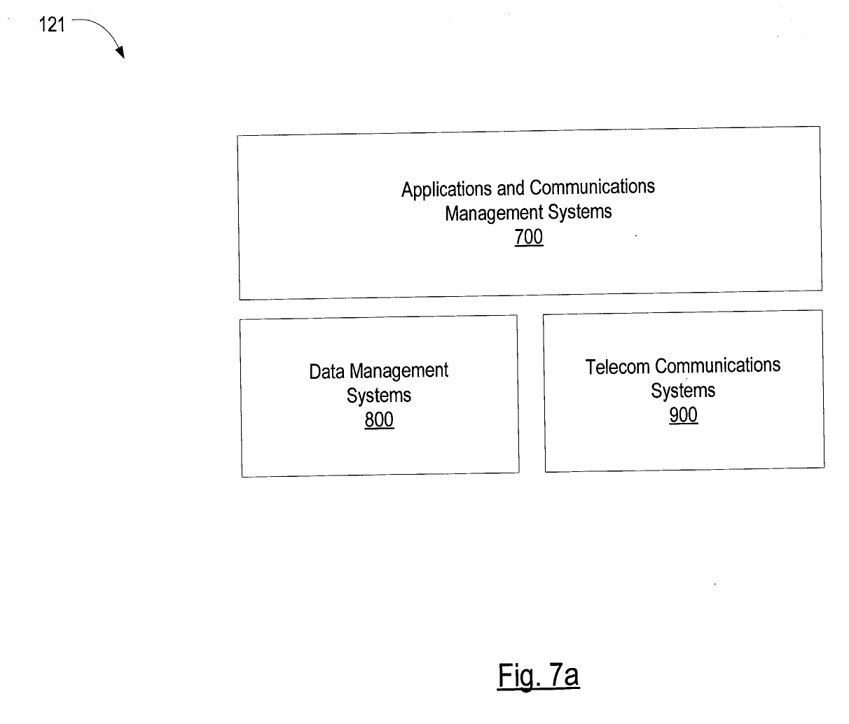

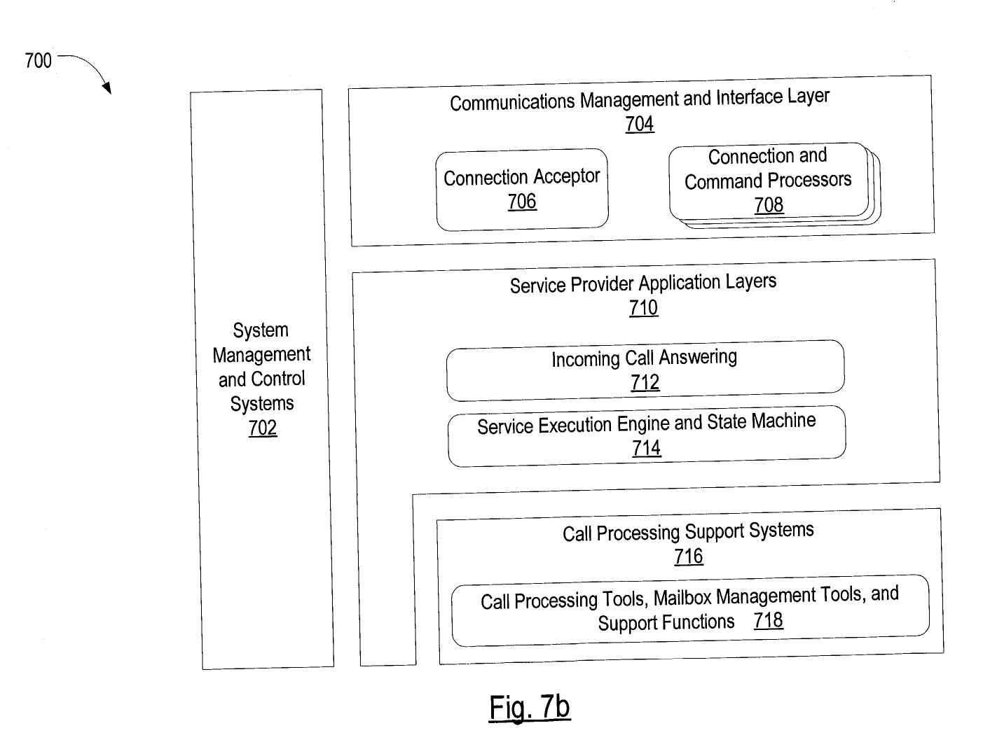

FIG. 7a is a block diagram of components of the server program 121 shown in FIG. 1. The server program includes applications and communications management systems 700, data management systems 800 and telecom communication systems 900.

FIG. 7b is a block diagram of the applications and communications management systems 700 shown in FIG. 7a, which includes system management and control systems 702, communications management and interface layer 704 that includes a connection acceptor 706 and connection and command processors 708; service provider application layers 710 that include incoming call answering 712, and a service execution engine and state machine 714; call processing support systems 716 that include call processing tools, mailbox management tools and support functions 718.

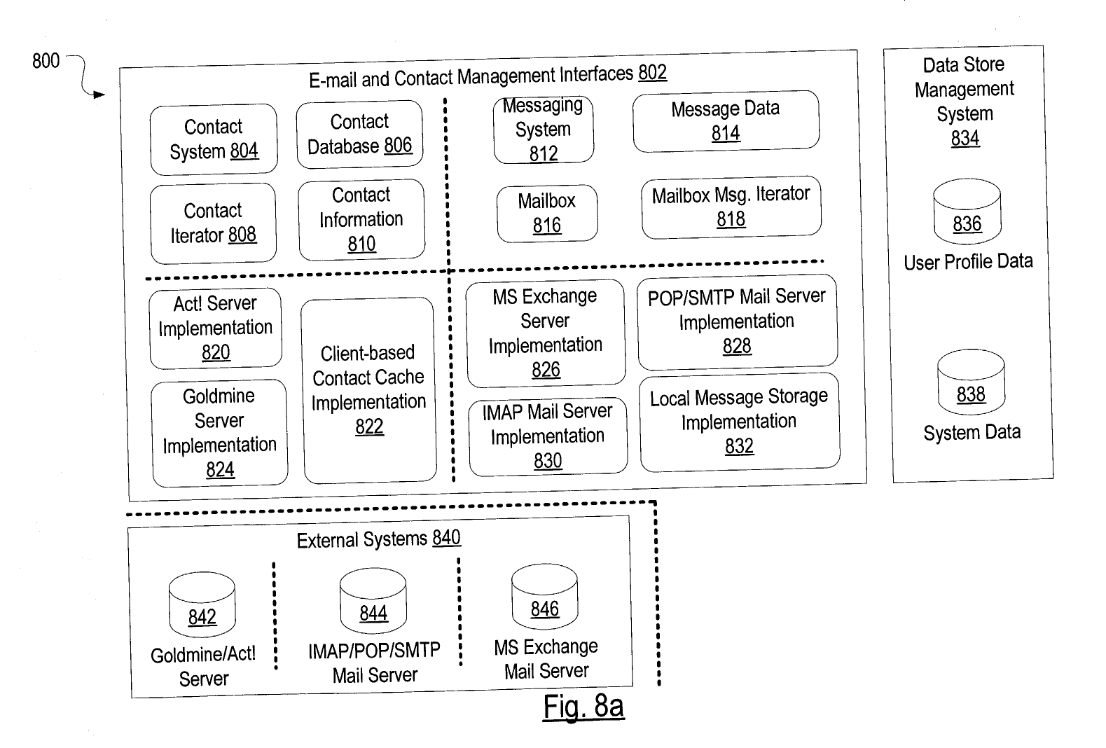

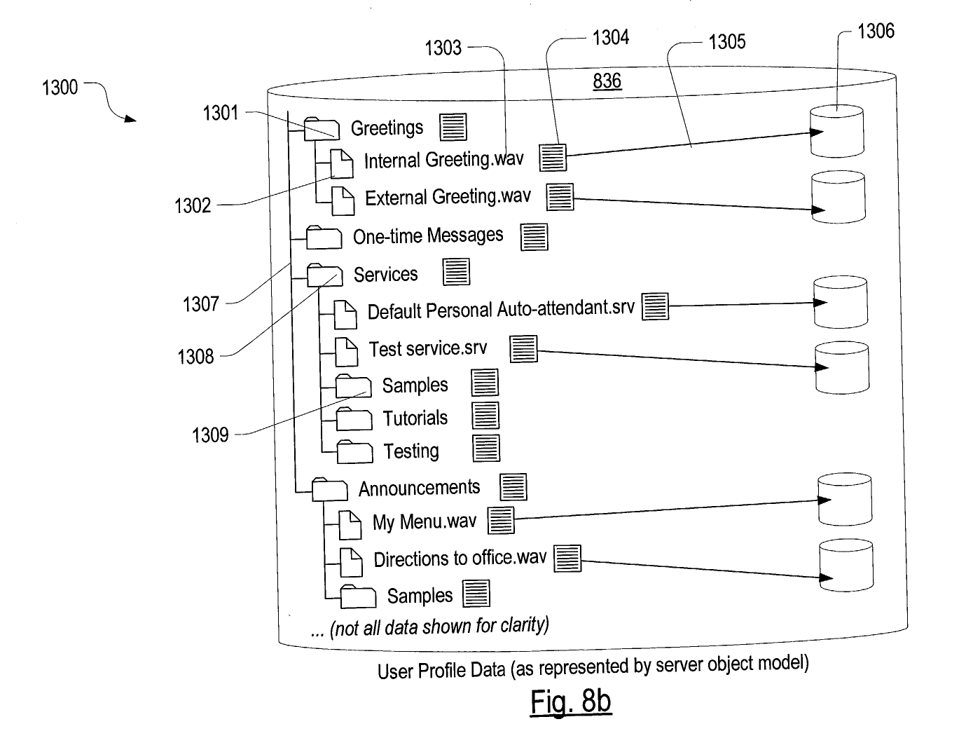

FIG. 8a is a block diagram of the data management systems 800 shown in FIG. 7a, which includes email and contact management interfaces 802, a data store management system 834, and external systems 840. The email and contact management interfaces 802 include a contact system 804, a contact database 806, a contact iterator 808, contact information 810, a messaging system 812, message data 814, a mailbox 816, a mailbox message iterator 818, an Act!® server implementation 820, a client-based contact cache implementation 822, a Goldmine® server implementation 824, an MS Exchange® server implementation 826, a POP/SMTP (post office protocol/simple mail transfer protocol) mail server implementation 828, an IMAP (Internet message access protocol) mail server implementation 830, and a local message storage implementation 832. The data store management system 834 includes user profile data 836, and system data 838. The external systems 840 include a Goldmine®/Act!® server, an IMAP/POP/SMTP mail server 844, and an MS Exchange® mail server 846.

FIG. 8b is a block diagram 850 of an example of the user profile data 836 shown in FIG. 8a, which includes folder objects 852 (‘Greetings’ in this example) that may contain other folder objects (not shown). The folder objects 852 contain objects 854 (‘Internal Greeting.wav’ in this example) which have an object name 1303, basic object data 858, a pointer 860 to an object file 862. Folder objects 852 and objects 854 are connected in a hierarchy by a tree-line 864. The user profile data 836 also includes a services folder object 866, which includes samples, tutorials and testing folder objects 870, for example.

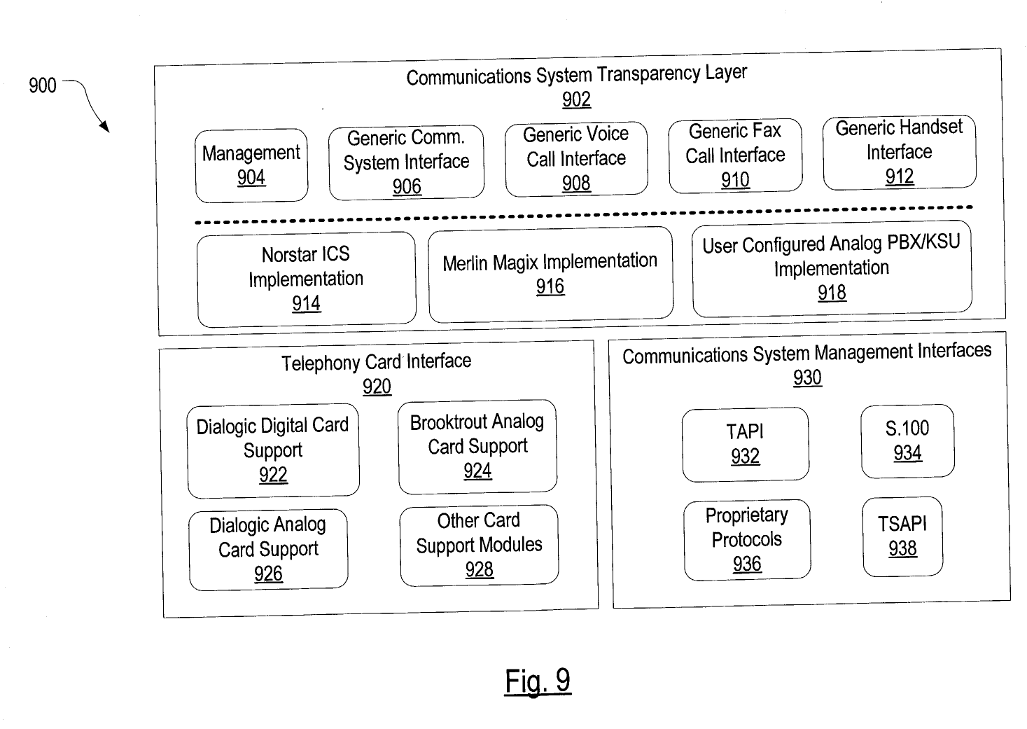

FIG. 9 is a block diagram of the telecom communication systems 900 shown in FIG. 7a, which includes a communications systems transparency layer 902, a telephony card interface 920, and communication systems management interfaces 930. The communication systems transparency layer 902 includes a management module 904, a generic communication systems interface 906, a generic voice-call interface 908, a generic fax call interface 910, a generic handset interface 912, a Norstar ICS® implementation 914, Merlin Magix® implementation 916, a user configured analog telephone system implementation 918. The telephony card interface 920 includes Dialogic® digital card support 922, Brooktrout® analog card support 924, Dialogic® analog card support 926, and other card support modules 928. The communications systems management interfaces 930 include TAPI (telephone applications programming interface) 932, an S.100 interface 934, which is well known in the art, proprietary protocols 936 and TSAPI (telephony server applications programming interface) 938.

The invention provides a system and methods that permits a user 110 to create a call flow map and a call handling behavior using the service editor 230 (FIG. 2b) to create services that can then be activated on the CTI server 120 (FIG. 1), which handles calls to the user's extension 109, and processes the call according to the call flow behavior defined by the user's activated service.

The invention also permits the user 110 to use features available in the server program 121 in their personalized message handling services. The user can customize their call flow so that it responds differently to different contacts in the user's personal contact management system.

The server program 121 is the principal processing component of the system, and provides personal data storage for each user. Users operate their client computers 116, which are connected to the TCP/IP-based LAN 122, to communicate with the server program 121 to configure and modify their personal call answering behaviors. The user's computer 110 executes the client program 210, and the CTI server 120 executes the server program 121 in accordance with a client/server model well known in the art.

The exemplary call flow map 300 shown in FIG. 3 is created using elements 302,320,336,364,372 that are connected together using drag-and-drop techniques to create the call flow map 300 that describes how a call is to be processed, the notifications the user 110 receives, when and how messages are stored, what announcements and menu options are presented to the caller (not shown), and many other functions.

The ‘Play One-time Message’ element 302 (FIG. 4), labeled ‘Play One-time Message’ 304b (FIG. 3), scans the user's profile 836 (FIG. 8b) to locate any one-time messages for a caller (as identified by matching Caller-ID information to contact information in the user's contact database). If a match is found, the one-time message is played 308, and the flow of the call passes through the adjacent connector pin 316 and the connection 317 to the connector 334 ‘Advanced Menu’ 338 element. If a one-time message is not located 306, the flow of the call passes through the adjacent connector pin 312 through the connection 314 to the connected 318 call control element 320.

The call control element 320 activates the ‘Play Mailbox Greeting’ 322b, which plays audio over the calling line to the caller based on an announcement object or a greeting, as selected by the user 110. The user 110 constructing the service selects the desired option by setting the appropriate fields 324. The user 110 also specifies 326 whether the caller can skip over the audio by pressing a DTMF (dual-tone multiple-frequency) key on their phone, or are unable to terminate the announcement object or greeting. The call flow always passes from the call control element 320 through connector pin 328, and follows the attached connection 330 to the connector 332 to an ‘Advanced Menu’ call control element 336.

The ‘Advanced Menu’ call control element 336, labeled ‘Advanced Menu’ 338b, permits the caller to enter DTMF digits until a specified timeout occurs. In this example, the timeout is configured as 0.0 seconds 340. This causes the call flow to pass straight through to the connector pin 346 if a DTMF digit has not been entered prior to entry to the ‘Advanced Menu’ element. This configuration of the call control element 336 permits the caller to press ‘*’ during their greeting if they would like to manage their mailbox. This behavior is provided by configuring a key (DTMF tone) in the advanced menu element 336 as ‘*’ 344, and connecting 360,362 a ‘Manage Mailbox’ element 372 to the associated connector pin 358 by dragging the call control element 372 onto the connector pin 358, as described above. The ‘unlisted key’ option 342 is also enabled so that DTMF tones (or keys) other than those listed explicitly in the ‘Advanced Menu’ element (in this case, ‘*’) will pass through the associated connector pin 352. In summary, if the caller presses the ‘*’ key on their phone during the one-time message or audio prompt played by the ‘Play Announcement’ element 320, the call will follow the connection 360 to the ‘Manage Mailbox’ element 372, otherwise, if they press any other key on their phone, or press nothing at all, which follows the timeout connector pin 346, the call will follow the connections 348,354 to the connected 350,356 ‘Take Message’ element 364.

The ‘Take Message’ element 364 records audio from the call until specified termination conditions 368 are met. It will store the audio as a voice message in the specified mailbox 368, which may reside on an external email server 844,846 (FIG. 8a) as specified using the email management interfaces 802, or in the user's profile data 836. The message is stored with information about the call, including Caller-ID and date/time information. The call flow then follows the only connector pin 370 on this element. Since this is not connected to any other elements, the call is disconnected.

The ‘Manage Mailbox’ element 372 prompts the caller to enter a password. The password is then matched against the password for the selected mailbox 376. If the password matches, the caller is able to check messages, and perform other mailbox management functions on the selected mailbox. Once, the caller leaves mailbox management, the call flow follows the adjacent connector pin 380. Since the connector pin 380 is not connected to any other elements, the call will be disconnected. If the password does not match, too many attempts are made, or the caller cancels password entry so that access is canceled 378, the call follows the adjacent connector pin 382. Since the connector pin 382 is not connected to any other elements, the call will be disconnected.

Each of the call control elements 304,322,338,366,374 include the icons 304a,322a,338a,366a,374a, which provide a graphical representation of the type of call control element, and the labels 304b,322b,338b,366b,374b, which permit the user to describe each element in their own words, if desired. Each call control element also includes T-bar control 304c,322c,338c,366c,374c that permits the user 110 to adjust a viewable size for the element, and a help button 304d,322d,338d,366d,374d which permits the user 110 to access help documentation for the specific element type.

The operation of the client program 210 will be described with reference to FIGS. 1, 2a, 2b, 3 and 4. In order to provide some of the custom call control features, the invention uses data stored in the mail and contact management system 202. The client programs 210 permits the user 110 to select personal contacts within certain of the call control elements available in the service editor 224, and when creating or modifying one-time messages for a specific caller. In order to display the list of personal contacts, the client program 210 interacts with the mail and contact management system 202 to retrieve a list of available contacts and their phone numbers. The list is then presented to the user in drop-down “combo boxes” so that the user may select either a personal contact, or add a personal contact to the list of contacts. Once a personal contact is selected, the client program 210 records information identifying the contact within the mail and contact management system 202 using a generic pointer so that the personal contact record can be retrieved again later by searching the mail and contact management system 202.

For server based contact management systems, both the client program 210 and the server program 121 access the contact management system 202.

In a preferred embodiment of the invention, Microsoft Outlook™ is used as the email and contact management system 202 in conjunction with Microsoft Exchange® as the email server 118, contacts are stored as a special type of message in a folder called Contacts in the user's mailbox. MAPI (messaging application programming interface) is used to access the mailbox, folder, and individual messages. Properties of the message are read to retrieve information about the personal contacts.

The main user interface 220 displays in the window 230 various data objects that represent data objects stored on the CTI server computer 120. Those data objects are manipulated in a known way, much like file objects in Windows Explorer®. The objects are stored in a file system-like structure as shown in FIG. 2b. Certain types of objects are stored in specific folders. For example, service objects 252 are stored in the folder named ‘Services’ 866 (FIG. 8a). The user 110 may create sub-folders within defined folders; for example, the user 110 may create a folder called ‘Services\Samples’ 870. Each type of object can contain two sets of data. The first set of data is basic data 858 that describes the object (and is often not changeable by the client program 210) such as a size of the object, or a last time the object was modified, or type of the object determines the actual data that would be available. The second set of data that may be stored for an object is file data 862; this data is associated by a pointer 860 with object using standard methods. For objects like services or announcements, the data consists of a binary data stream that corresponds to a file stored on disk by the server. The file data 862 can be retrieved by the client program 210, and opened using special editor programs, such as the service editor 224 and the Announcement Editor 222. The special editors are designed as custom OLE (object linking and embedding)-based document editors, much like most desktop applications like Microsoft Word® or Corel Draw®. Some of the objects, such as announcements, use common data formats like the RIFF/WAVE file format used for standard .WAV files in Windows®. The service object 252 file format, however, is stored using a proprietary data format, which will be described in more detail below.

The service object 252 (FIG. 2b) contains data describing how a call should be processed. A user 110 can activate a service on their extension, and the server program when processing a call for that user will use the chosen service as it processes the call for the user's extension telephone 112.

To modify a service object, the user 110 double-clicks on the service object using the mouse 116a. This will cause the client program 210 to retrieve the service data object 252 from the server program 121. Once the data has been retrieved from the CTI server 120, the client program 210 opens the service editor 224 on the service data object 252. The server data object is stored on the client computer 116 as a service file. The data format for this file consists of a sequence of Microsoft Foundation Classes (MFC) CObject-based element classes that have been serialized to disk as part of a document, which is done using standard techniques. The specific details of the file format are not important so long as both the server and client program use the same method of storage and retrieval. After the user has completed editing the service object 252, the data is retrieved to the server for storage.

The user may create, delete, rename, and modify all data objects that are stored on the server. In addition, a single service object 252 may be activated on the user's extension telephone 112. This is done by either dragging the desired service object to the line status bar 260 located as a separate pane at the bottom of the user's main window 230 and dropping it on the active service area 264 (implemented using standard drag and drop techniques), or by selecting the Activate service menu item 272 while the desired service object 252 is selected in the pane 250 displaying the list of service objects (implemented using standard context menus). Both these procedures cause the client program 210 to instruct the server program to activate the specified service object for call processing on the user's telephone extension. Activation of the service is performed by modifying the user's profile data 836. The client program sends a command to the server indicating that the user's profile 836 should be changed so that the desired service object becomes the active service.

In addition to service objects 252, the user 110 may manipulate the following other objects: announcements (audio files played over the phone to callers), fax documents, fax cover page templates, one-time messages, fax queue entries, and event log archives. These are all performed in a similar manner to that described above for service objects.

It should be noted that elements within service objects often refer to other objects within the user profile including announcements, contacts, fax documents, and fax cover pages templates. Each of these objects within the service object is referred to by an object reference. The object reference is much like a file name path for referring to files on a disk, however, each user's object space is restricted to objects that they can manipulate and see. All of the objects in each user's profile are distinct and are manipulated independently from objects in other user's profiles. In one embodiment of the invention, the server program is responsible for ensuring that a user may not manipulate, or even see, objects in other user's profiles.

The service editor 224 permits the user 110 to manipulate call flow behavior using call flow maps 300. As shown in FIG. 4, the call flow map 300 is presented to the user as a visual image. Behavioral and decision-making blocks are represented by call control elements 302,320,336, for example, that are inserted into the call flow map 300. Dragging and dropping call control elements 404a (see FIG. 5a) from the call control element palette 404 onto connector pins (pin 312 in this example) that extend from a side of other call control elements make the logical connections between the elements. The user can also use the mouse 116a to create a connection between any connector pin and another call control element. Any existing connection between the elements from the origin connector pin are automatically replaced the new connection. Users are also permitted to create connections that ‘loop-back’ to elements that are located earlier in the logical flow of the call, as shown in FIG. 5d.

A feature of the service editor 224 is that each element presents all of the data required to configure it on the same screen, as the connections are made. The invention does this in a manner that makes creating a call flow map simple and easy for the user 110. Another distinct feature about call control elements that are available for a user 110 to use while constructing a call flow map is that call control elements are high level implementations of control logic. This greatly simplifies the learning required by an end user, while only marginally limiting the capabilities available to the user 110.

The service editor 224 also provides the user 110 with the ability to show or hide extra details about elements in the service that they do not need to see at any given time. This permits the user to reduce or increase the information presented on the screen to ease in the management and modification of a service.

The following (Table 1) is a list of elements that are currently available to users 110 of the invention:

TABLE 1

| Element | Description |
|---|---|
| Advanced Menu | Allows the caller to choose a path |
| | with-in the call flow based on DTMF |
| | (dual tone multi-frequency) digits. |
| Change | Allows the caller to change the |
| Mailbox | password for a specified mailbox. |
| Password | |
| Compare | Compares DTMF digits entered by a |
| Digits | caller to specified patterns and |
| | directs the call flow accordingly. |
| Compare | Compares a selected extension against a |
| Extension | list and directs the call accordingly. |
| Deliver | Delivers messages (voice, fax, email, |
| Messages | etc.) to a sequence of phone numbers as |
| | part of a feature called Active Message |
| | Delivery. |
| Dial by | Permits the caller to dial an extension |
| Extension | and be transferred to that extension. |
| Dial by Name | Permits the caller to dial a user's |
| | extension by entering their name. Upon |
| | a match, the call will be transferred |
| | to the selected user's extension. |
| Fax-on-Demand | Permits the caller to enter a fax |
| | number to which fax-on-demand documents |
| | are to be sent. |
| Flow Control | Permits the call flow to be directed |
| | based on time-of-day/day-of-week, and |
| | by Caller-ID. |
| Gather Digits | Gathers digits from the caller that can |
| | be used later to direct the call flow. |
| Hang Up | Hangs up the call. |
| Loop Counter | Counts the number of times a call |
| | control element is encountered, and |
| | follows a different call flow path |
| | after a number of passes through the |
| | call control element. |
| Manage | Permits the caller to log in to manage |
| Mailbox | their mailbox. |
| Menu | Plays an audio prompt, and then permits |
| | the caller to select a call flow path |
| | based on a DTMF digit. |
| Notify Pager | Notifies a paging device with |
| | information about the call or latest |
| | message left. |
| Play | Plays an audio announcement to the |
| Announcement | caller. |
| Play One-time | Plays a one-time message associated |
| Message | with a particular contact to a caller. |
| Receive Fax | Receives a fax document. |
| Record | Records over an existing audio file or |
| Announcement | greeting. |
| Select | Allows the caller to select an |
| Extension | extension using DTMF tones. |
| Send Fax | Sends a fax document to a specified |
| | number. |
| Take Message | Records an audio message from the |
| | caller and stores it in the user's |
| | mailbox. |
| Text-to-Speech | Reads text to the caller using a |
| | Text-to-speech engine. |
| Transfer Call | Transfers the call to an internal or |
| | external phone number. |
| Verify | Permits the caller to enter a numeric |
| Password | password using DTMF tones, and compares |
| | it to the specified password before |
| | continuing in the call flow. |
| Voice Mail | Performs standard voice mail functions |
| | (plays a greeting and takes a message) |
| | with support for one-time messages, |
| | mailbox management, and a single layer |
| | special menu for allowing features such |
| | as ‘press 1 to reach me on my |
| | cell-phone’, etc. |

The service editor 224 also provides an overview pane 402 that permits the user 110 to view an entire service 300 as it is created. This permits a user 110 creating large services to have an overview of the flow of the service, and to understand where a currently displayed area 406 of the service fits into the entire service.

The client program 210 communicates with the server program 121 using a protocol that operates over TCP (transport control protocol) The protocol supports a set of general behaviors shown in Table 2, which can be implemented using techniques known to those skilled in the art:

TABLE 2

| Behavior | Action |
|---|---|
| Login | Performs verification of user |
| | identify and restricts user |
| | access to data pertaining to |
| | their profile. |
| Get list of objects | Lists all objects of a |
| | particular type within a |
| | particular folder in a user's |
| | profile. |
| Create object | Creates a new (empty) object |
| | on the server within the |
| | user's profile |
| Delete object | Deletes an existing object on |
| | the server from within the |
| | user's profile. |
| Rename object | Renames an object. |
| Set object | Sets data for an object. |
| Get object | Gets data for an object. |
| Get/set file data for | Gets or sets file data for an |
| object | object. |
| Get/set options | Gets or sets behavioral |
| | options for the user's |
| | profile. |

The client program 210 maintains one TCP connection to the CTI server 120 for management and control functions (as in sending the above, commands, and handling their replies). A separate TCP connection is established as required when file data is transferred for an object. This is implemented using common TCP and FTP-style (file transfer protocol) semantics.

The server program 121 is created as either a Windows NT® service or a Unix® daemon (a program that runs in the background and is managed by an operating system) so that it may be run automatically at system start-up, and without specific need for a user to logon to the computer. The server program 121 also stores configuration data in a folder on a disk in the computer so that it may retain its settings between restarts of the computer. The server program 121 is implemented as a multi-threaded application, permitting it to perform parallel actions at the same time. Many different sub-systems within the server program 121 run their own threads to perform background processing, or to actively wait for input data before performing processing related to that input data.

The server program 121 creates management objects 704 that create a TCP listening socket through the connection acceptor 706 (FIG. 7b). The listening socket accepts a connection from the client computer 116. For each connection that is accepted, a new thread is generated to receive commands from the client program 210, and to dispatch replies and event notifications to the client program 210. In addition, separate threads are used to process commands received from the client program 210 so that more than one command can be processed at a time. All responses to client commands are tagged with a client-associated tag that was transmitted in the command so that the client program can clearly identify to which command the reply applies. The command processing objects dispatch the operational processing of the command to objects created within the server program 121 that are responsible for managing data or systems associated with the command. This program structure uses common server development techniques that are well known to those skilled in the art.

The invention utilizes common computer telephony hardware to integrate with communication systems. The hardware is provided with a programming API that permits developers to interact with the hardware in such a way as to perform operations such as placing a call, answering a call, detecting DTMF digits, and playing and recording audio.

The invention uses specific integration techniques for different telephone systems. Integration is accomplished either through specific digital integration, or in-band detection of DTMF digits over analogue channels to determine a reason for a call arriving at an integration port (or channel) between the telephony and interface 920 (FIG. 9) and the telephone system 108.

Once the call arrives from the telephone system 108 to the telephony card interface 920, the communication system management interfaces 930 utilize the information made available by the telephone system 108 to determine which extension the call arrived from. It then consults its user profile data storage 834 to determine how to go about answering the call. The service is then loaded into memory, and executed by the service execution engine 714.

In order for a call to arrive at the telephony and interface 920, the communication system must be programmed accordingly to direct the call correctly for the desired circumstances (such as the user not answering their phone). The server program 121 automatically programs the telephone system 108 to direct the calls accordingly. Different integration methods are used for different types of telephone systems to accomplish this, however, the management interface presented to the administrator is very similar or identical, regardless of the type of telephone system that is connected to the call-processing server. A compatibility layer that isolates the system management functions and call processing layers from the telephone system and other device specific functionality enables the consistency in the management interface. The compatibility layer, which includes communication system programming reduces management overhead, and simplifies the process of installation, configuration, and general use of the system in accordance with the invention.

The invention also enables integration with an email system for storage of voice and fax messages. This functionality is referred to as unified messaging. The integration of the email system is provided by a messaging layer that hides the specific details of the messaging system and provides a common abstract interface that can be used by call processing layers of the server program 121 to perform the desired processing requested by the end user 110. Contact management integration is provided in a similar manner, so that regardless of the system used by the user, the integration and call processing layers used for executing services, are able to function.

The messaging layers are built by first constructing an abstract set of objects that provide the following behavioral interfaces: Messaging System 812, Mailbox 816, Mailbox Message Iterator 818, and Message Data 814. For each messaging system that is to be supported, a refinement of each abstract interface is implemented such that behavior is implemented correctly. The interfaces are adapted to handle email, fax, and voice messages. Voice and fax messages are treated as special types of email messages that have attachments containing the voice and fax data, sent with a regular email message body and header. Table 3 details functionality of each of the interfaces identified above:

TABLE 3

| Interface | Functionality |
|---|---|
| Messaging System | Opens and closes connections to |
| | the messaging system, maintains |
| | connections to the messaging |
| | system, for indicating if a |
| | messaging system can open a |
| | particular mailbox, and for |
| | opening mailboxes. Also oversees |
| | open mailboxes, and maintains |
| | all objects for the messaging |
| | system to which it provides |
| | access. |
| Mailbox | Adds messages to a mailbox, |
| | sends messages on behalf of the |
| | user who owns the mailbox, |
| | accesses different folders |
| | within the mailbox, provides |
| | access to a Mailbox Message |
| | Iterator interface, and deletes |
| | and modifies messages within the |
| | mailbox. |
| Mailbox Message | Steps through messages in a |
| Iterator | mailbox folder, and provides |
| | access to information about each |
| | message using the Message Data |
| | interface. |
| Message Data | Provides access to common email |
| | message data such as the list of |
| | recipients, the sender, the |
| | subject, the message body, the |
| | date and time of the message, |
| | the ‘read’ flag, and the message |
| | attachments. |

The contact management interface is built using a slightly different version of the same style of system. The abstract set of interfaces that are constructed include: Contact System 804, Contact Database 806, Contact Iterator 808, and Contact Information 810. A significant difference arises because all contact management systems are server based. Consequently, a special contact system (and related interfaces) is implemented to provide local caching of client-side contact data. As with the messaging system, for each contact management system that is to be supported, each of the interfaces for providing specific behavior are implemented. One significant difference between the messaging system 812 interface and the contact management system 804 interface is that there is no requirement for the data in the contact management system to be modifiable by the server program 121. The server program 121 only needs to be able to read and refer to information contained in the call management system. Table 4 details the functionality of each of the interfaces identified above:

TABLE 4

| Interface | Functionality |
|---|---|
| Contact System | Opens and closes connections to |
| | the contact management system, |
| | maintains connections to the |
| | contact management system, |
| | indicates if a contact system |
| | can open a particular contact |
| | database, and opens contact |
| | databases. Also oversees open |
| | contact databases, and maintains |
| | all objects for the contact |
| | management system to which |
| | access is provided. |
| Contact Database | Provides fast searching |
| | capabilities for matching |
| | contacts with particular |
| | Caller-ID information, and |
| | provides access to a Contact |
| | Iterator interface so that |
| | contacts can be located within |
| | the contact database. |
| Contact Iterator | Iterates through objects in the |
| | contact database and provides |
| | access to data for individual |
| | contacts using the Contact |
| | Information interface. |
| Contact Information | Provides access to specific |
| | information about a particular |
| | contact, including the contact's |
| | name, phone numbers, and email |
| | addresses. |

These contact and messaging layers are used by the service execution system to provide the functionality of the invention.

Execution commences once it has been determined that a call arriving at one of the CTI server's 120 integration ports is determined to be for a user's extension telephone 112, and that the user 110 has activated a service object. Service execution is performed using three main components. These components are the Service Execution Engine and State Machine 714, the Voice Call, and the Call Processing Tools 718.

The Voice Call is a mid-level layer that provides a telephone system and telephony card independent interface to the port used to process the call. The Call Processing Tools 718 are a set of utility functions that provide a range of common functions that are used by a number of elements of the server program 121 to implement behaviors in response to telephone calls. The Service State Machine 714 is responsible for translating the call flow map (composed of elements and connections) into a sequence of calls to the Call Processing Tools 718 and Voice Call functions, in order to provide the behavior required for the service elements.

A service is executed by implementing a pseudo-state machine 714, where each call control element (for example, call control elements 302,320,336,364,372 shown in FIG. 3) is a state, and each connection (for example, connections 314,317,330,348,354,360 shown in FIG. 3) is a transition between states. Each call control element 302,320,336,364,372 is associated with a corresponding method (not shown) in the Service State Machine object that is invoked through a generic dispatcher. Each method returns a next call control element to be executed, as defined by a connection leaving the call control element. The internal logic in the call control element determines which connection is selected. If a call is lost at any point during the execution of a service, execution continues until a loop is encountered. This is done to ensure that call control elements that do not require an active call, such as pager notification, are processed to ensure that the user receives notifications of message being left, even if the caller hung up before they finished leaving the message.

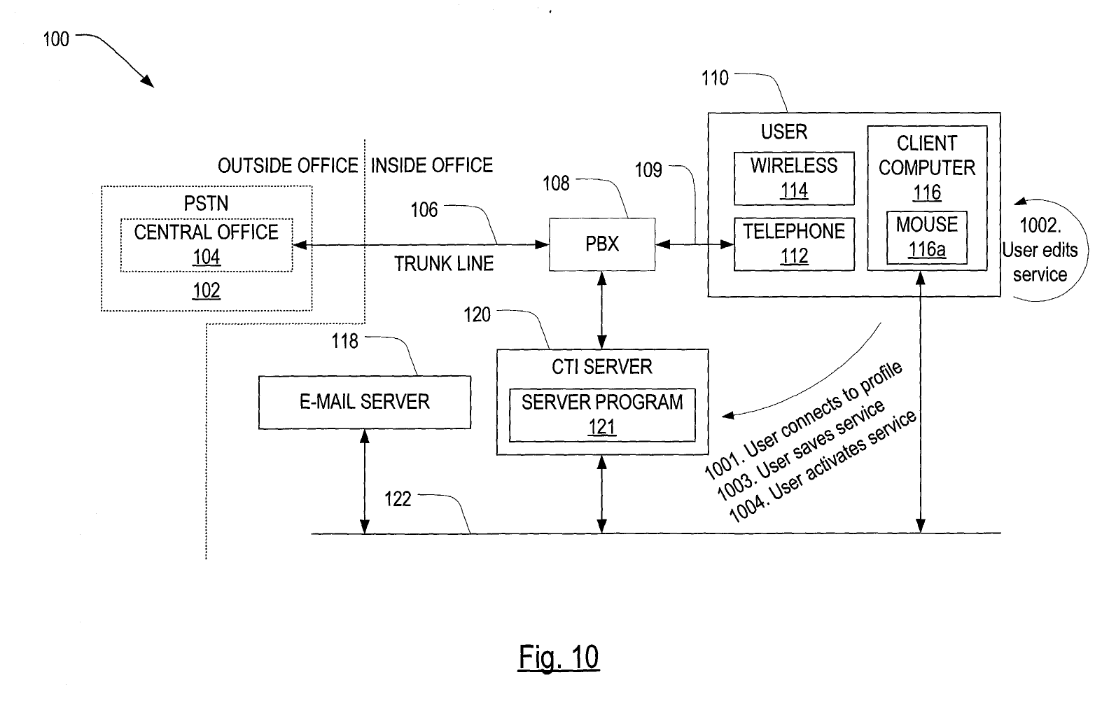

FIG. 10 summarizes the process by which a user 110 configures a new or existing call flow map. In step 1001, the user 110 connects to a personal profile 836, and views current data and configuration. The user 110 creates or modifies an existing service object using the service editor 224 to define a call flow behavior for their extension (step 1002). The user 110 saves the service object, causing it to be stored back to the CTI server 120 (step 1003). The user 110 finishes the process by instructing the call-processing server program 121 to activate the service on the telephone extension 109 (step 1004).

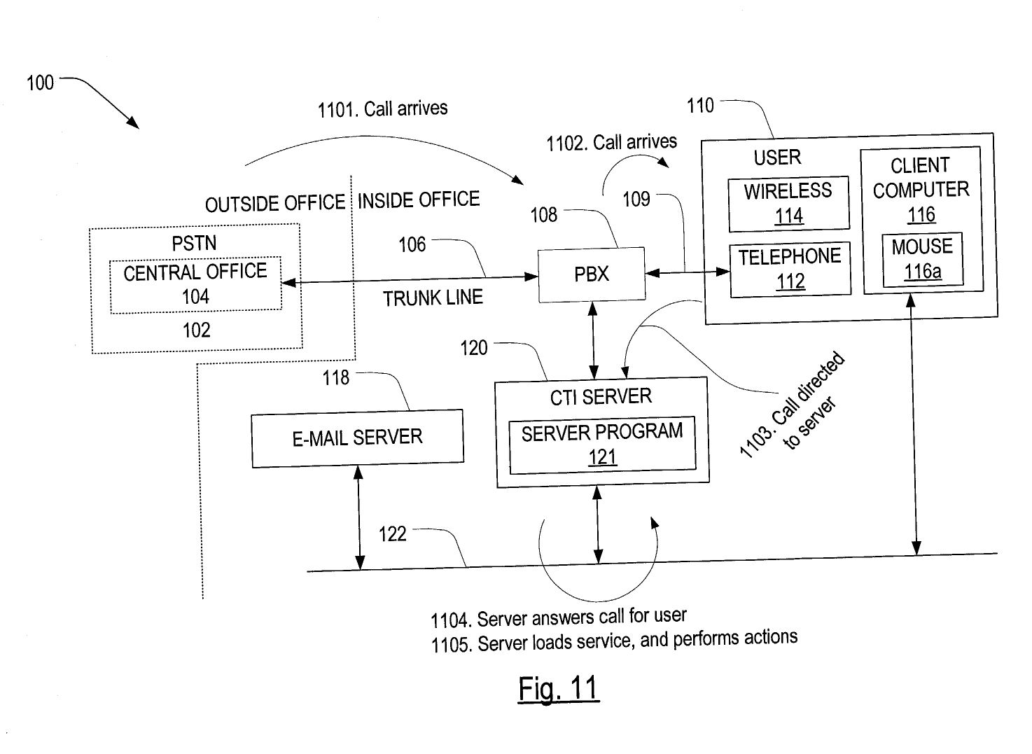

FIG. 11 summarizes the handling of in-coming calls by the system in accordance with the invention. In step 1101, a call arrives for the user's extension telephone 112, either from PSTN 102 or from an internal extension (shown as step 1102). The telephone system 108 may perform call routing, or relay the call to a secondary system, such as an auto-attendant embedded in the call-processing server program 121, to deliver the call to the user's extension 112. In step 1103, the call redirected to the CTI server 120, either by the telephone system 108 responding to programmed instructions associated with the user's extension telephone 112, or by a monitoring agent in the Communication System Management Interfaces 930 of the call processing server program 121. The call is then answered by the server program 121, and the call is identified by the Communication system Management Interfaces 930 as to which user's extension telephone 112 it was originally targeted using known techniques (step 1104). In step 1105, the server program 121 then loads the user's activated service from the user's profile data 836, and executes the actions defined by the loaded service.

The invention therefore provides a communication system that permits users within an office to have personalized call processing and notifications that are customizable based on personal contacts. It also permits personalization of call flow behavior in an extensible manner, without requiring extensive knowledge of the system by the user.

The embodiment(s) of the invention described above is(are) intended to be exemplary only. The scope of the invention is therefore intended to be limited solely by the scope of the appended claims.

We claim:

1. A communications system for use in conjunction with a telephone system connectable to a telephone network, the telephone system supporting a plurality of extension telephones connected thereto and used by a plurality of users with personal computers connected to a computer network, the system comprising:
a CTI (computer telephony integration) server connected to the computer network, the CTI server executing a server program that executes computer instructions for handling calls to at least selected ones of the plurality of extension telephones; and
a client program operably installed on the personal computers, each client program comprising means for configuring the server program to execute the computer instructions for handling calls to an extension telephone of the user.

2. The communications system as claimed in claim 1 further comprising an e-mail and contact management system connected to the network.

3. The communications system as claimed in claim 2 wherein the client program further comprises a contact management program.

4. The communications system as claimed in claim 2 wherein the server program further comprises a contact management system.

5. The communications system as claimed in claim 1 wherein the means for configuring the server program comprises a service editor with a graphical user interface (GUI).

6. The communications system as claimed in claim 5 wherein the service editor comprises means for creating a call flow map that is used for configuring the server program.

7. The communications system as claimed in claim 6 wherein the service editor further comprises means for editing the call flow map used to configure the server program.

8. The communications system as claimed in claim 5 wherein the service editor further comprises means for saving the call flow map on the CTI server.

9. The communications system as claimed in claim 6 wherein the call flow map comprises call control elements representing predetermined call handling behavior performed by the CTI server during the handling of calls.

10. The communications system as claimed in claim 9 wherein a call flow through the call flow map is determined by connections established between call control elements of the call flow map.

11. The communications system as claimed in claim 1 wherein the server program comprises service providing application layers.

12. The communications system as claimed in claim 11 wherein the service providing application layers comprise a service execution engine and state machine for translating a call flow map into a sequence of executable program instructions.

13. The communications system as claimed in claim 12 wherein the server program comprises call processing support systems for executing the sequence of executable program instructions.

14. The communications system as claimed in claim 13 wherein the call processing support systems comprise call, processing tools and support functions.

15. A method of permitting an individual user of an extension telephone to configure the handling of calls to the extension telephone, the extension telephone being connected to a telephone system connected to a telephone network, the method comprising steps of:
communicatively connecting a client program operated by the individual user to a server program that executes on a computer telephony integration (CTI) server configured to receive notice of the calls to the extension telephone and to control handling of the calls;
creating a call flow map that defines how the calls are to be handled using the client program operated by the individual user; and
operating the client program to store the call flow map on the CTI server.

16. The method as claimed in claim 15 further comprising a step of communicatively disconnecting the client program from the server program.

17. The method as claimed in claim 15 further comprising a step of executing the server program to activate a service defined by the call flow map to handle an call to the extension telephone.

18. In a communications system including a network; a CTI (computer telephone integration) server connected to the network; a telephone system connected to the CTI server and to a telephone network; and a plurality of extension telephones connected to the telephone system, a method for processing calls to the plurality of extension telephones, the method comprising steps of:
receiving the call at a CTI server, which executes a predetermined service defined by a user of a destination extension telephone for the call using a client program; and
handling the call at the CTI server in accordance with the predetermined service.

19. A method as claimed in claim 18 wherein the step of handling the call further comprises a step of:
determining an identity of a calling party associated with the call.

20. A method as claimed in claim 19 wherein the step of handling the call further comprises a step of:
delivering a unique message to the calling party based on the calling party's identity.

21. A method as claimed in claim 18 wherein the step of handling the call further comprises a step of:
accepting a voice mail message from the calling party;
storing the voice mail message as a data file;
attaching the data file to an electronic mail message; and
sending the electronic mail message from the CTI server to a mailbox of the user.

22. A computer readable medium storing program instructions executable by a client computer in a server/client computing model, comprising:
program instructions for communicatively connecting the client computer to a server program executing on a computer telephony integration (CTI) server;
program instructions for permitting a user of an extension telephone served by a telephone system to which the CTI server is connected to create at least one call flow map for controlling calls to the extension telephone; and
program instructions for saving call flow maps created by the user on the CTI server.

23. A computer readable medium as claimed in claim 22 wherein the program instructions for permitting the user to create at least one call flow map further comprises:
program instructions for permitting the user to create the call flow map using predefined call control elements that are dragged and dropped onto a call flow map creation window.

24. A computer readable medium as claimed in claim 23 wherein the program instructions further comprise:
program instructions for defining at least one connector pin associated with each call control element, and for displaying the at least one connector pin when the call control is dragged and dropped onto the call flow map creation window.

25. A computer readable medium as claimed in claim 24 wherein the program instructions further comprise:
program instructions for automatically creating a connector between first and second call control elements when the second call control element is dragged and dropped on connector pin of the first call control element.

26. A computer readable medium as claimed in claim 25 wherein the program instructions further include:
program instructions for automatically creating a connection between a connector pin and a call control element when the connector pin is dragged and dropped on the call control element.

27. A computer readable medium as claimed in claim 26 wherein the program instructions further comprise:
program instructions for routing the automatically created connection around call control elements in the call flow map.

28. A computer readable medium as claimed in claim 25 wherein the program instructions further comprise:
program instructions for presenting in a single display all of the data required to configure each call control element.
